(19) United States
(12) Patent Application Publication
(10) Pub. No.: US 2006/0124046 A1
(43) Pub. Date: Jun. 15, 2006

(54) Using thin film, thermal batteries to provide security protection for electronic systems

(75) Inventor: Kenneth H. Heffner, Largo, FL (US)

Correspondence Address: Honeywell International Inc., Law Dept. AB2, 101 Columbia Rd., Morristown, NJ, 07962, US

(73) Assignee: Honeywell International, Inc.

(21) Appl. No.: 11/296,553

(22) Filed: Dec. 7, 2005

Related U.S. Application Data
(60) Provisional application No. 60/634,737, filed on Dec. 9, 2004.

(51) Int. Cl. G08B 3/02; G08B 17/04

(52) U.S. Cl. 116/67 R; 116/101

(57) ABSTRACT

The present invention provides electronic systems that include thin film thermal batteries incorporated in the electronic system to provide a security function.

### CROSS-REFERENCE TO RELATED APPLICATION

The present non-provisional Application claims the benefit of commonly owned provisional Application having Ser. No. 60/634,737 filed on Dec. 9, 2004, and entitled Using Thin Film, Thermal Batteries to Provide Security Protection for Electronic Systems, which Application is incorporated herein by reference in its entirety.

### TECHNICAL FIELD

The present invention relates to electronic systems that include thermal batteries. More particularly, the present invention relates to the use of one or more thin film thermal batteries with an electronic system to provide a security function.

### BACKGROUND

Electronic systems often incorporate valuable structures, software code, data, and intellectual property. These valuable items are targets of espionage from competitors, foreign governments, and other adversaries. An unauthorized entity may attempt to gain possession of such systems and then use reverse engineering methodologies to harvest as much valuable technology as it can. Consequently, protective technologies are incorporated into electronic systems in order to frustrate these kinds of prying activities.

Security protection can be passive or active. Passive protection generally imposes barriers of some sort that can delay, prevent, or otherwise confound reverse engineering. Active protection imposes a penalty upon occurrence of one or more triggering events that indicate an unauthorized intrusion attempt is in progress. Because an important goal of active protection is to prevent valuable technology from falling into the wrong hands, the penalty typically may be to cause enough damage or destruction so as to render the workpiece valueless to the unauthorized investigator.

Active protection systems typically require power to monitor and react to events that signify an intrusion attempt is in progress. The power can come from several sources such as the power supply of the product being protected as well as external sources. Such sources may include standard batteries (Carbon, Zinc Chloride, Alkaline), lithium batteries, zinc-air batteries, and the like. The problem with using batteries as sources of power is the issue of limited shelf life as well as the need to maintain protective security functions with available power supply on demand over long periods of time. Indeed, some security applications may require a minimum ten-year shelf life. Over such a long period of time, the battery power could be depleted and would present the risk of failing to react to an intrusion event.

Thermal batteries are another potential power source. Conventional thermal batteries generally use inorganic salt electrolytes that are non-conductive solids at ambient temperatures but become active when melted. A thermal battery typically incorporates pyrotechnic materials that can be ignited to melt the electrolyte and activate the battery. An external energy impulse can be used to ignite the pyrotechnic materials. In turn, the electrolyte is melted, and the battery becomes conductive and produces high power for a short period of time (from a few seconds to an hour).

Thermal batteries have several advantages over other types of batteries, including tolerance of discharge conditions from open circuit to high current densities, large current capability, a simple construction, tolerance to processing variations, and stability in extreme dynamic environments. The shelf life of a thermal battery can be longer than ten years without degradation in performance. They can be dormant but then activated quickly on demand to provide power within fractions of a second. Their high peak-power density exceeds 10 watts per square centimeter. Thermal batteries are resistant to harsh environments, operate at many temperatures, are reliable after long-term storage, and require no maintenance. They are hermetically sealed, so they do not outgas, and most importantly, they can be custom designed for acute voltage, start time, and configuration requirements.

The disadvantages of a thermal battery include a very short activated life (usually under 60 minutes, often less than 10 minutes), low energy density, a surface temperature of 230° C. or higher, nonlinear voltage, and a one-time usage. Also, thermal batteries have tended to be bulky, making it impractical to incorporate them into microelectronic devices.

Thus, it has been a significant challenge to find practical power sources for active protection measures for electronic systems.

### SUMMARY

Thin film, thermal batteries are much more compact embodiments than their more conventional counterparts. The diminutive size of thin film thermal batteries makes it very practical to incorporate such thermal batteries into microelectronic packages and then use them to power active and/or passive security measures. Thus, the development of thin film versions of thermal batteries has presented an opportunity to solve the problem of powering active protection measures for microelectronic systems over very long periods of time. The power output lies essentially dormant but then can be caused to function on demand, even after many years of being inactive, to power structure, data and code protection operations. In short, the use of thin-film, thermal batteries to power security technologies solves the problem of limited and unreliable power supply that otherwise could result in catastrophic failure of the active security for products containing high-value structures, code, information, valuable intellectual property, and the like.

Also recognizing that thermal batteries output significant thermal energy in addition to electrical power, the development further allows thin film batteries to be strategically placed in close proximity to device structures to allow automated, physical self-destruct measures to be taken. The thermal energy released by these batteries can seriously damage or destroy device structures, code, and data resident in a protected product. The automated, self-destruction is driven by the intense heat (e.g. 500° C.-700° C. can be available) that can be yielded by the exothermic chemical reaction(s)that drive the electrochemical cell.

Although a thermal battery is capable of generating intense energy for relatively brief periods of time, it only takes a relatively minor amount of energy to initiate (e.g., to trigger the fuse of such as by igniting pyrotechnic material) a thermal battery and cause it to function. Thus, an illustrative mode of practice might involve incorporating power source features into a microelectronic system that generates perhaps only a modest energy output upon the occurrence of a triggering event indicating that the system is under investigation by an unauthorized source. The modest energy output may or may not be enough by itself to power security operations, but it is substantial enough to initiate the thermal battery. These sources of modest energy output desirably have a long shelf life commensurate with the desired security operations to be powered by the thermal battery. Preferred sources are those that are unpowered themselves, can remain dormant for extended periods, but become active and generate a power output upon occurrence of a triggering event.

Representative examples of such battery-initiating power sources include systems incorporating piezoelectrically functional materials such as torsional transducers, and the like. In the practice of the present invention, using more than one of such battery-initiating power sources may be preferred, inasmuch as redundancy tends to heighten security protection.

An illustrative mode of practice involves providing a security protection system that includes at least one, unpowered piezoelectric transducer, desirably at least one amplifier electrically coupled to the transducer(s) in a manner effective to generate the voltage required to trigger the fuse for the thermal battery to augment the output of the transducer(s), and at least one thermal battery electrically coupled to the amplifier(s). Preferably, at least one thermal battery can be positioned in close physical proximity to, e.g., on, one or more die components of a microcircuit assembly, and/or strategically embedded in a security perimeter material to obfuscate its presence in the design. The battery can be used to activate and power a circuit that controls and executes an algorithm that corrupts, erases, overwrites, or otherwise helps to prevent critical software residing on the assembly or component die from being reverse engineered.

Thin film, thermal batteries have been described in the following publications, each of which is incorporated herein by reference in its entirety: Hui Ye, Chris Strock, T. Danny Xiao, Peter R. Strutt, David E. Reisner, R. A. Guidotti, and F. W. Reinhardt, “Novel Design and Fabrication of Thermal Battery Cathode Using Thermal Spray,” presented at Fall MRS Mtg., Boston, Mass., Nov. 30-Dec. 4, 1998, publ. in MRS Symp. Procs., Vol. 548, Solid State Ionics V, eds., G.-A. Nazri, C. Julien, and A. Rougier (Mats. Res. Soc., Warrandale, Pa., 1999), pp. 701-707; R. A. Guidotti, F. W. Reinhardt, H. Ye, T. D. Xiao, and D. E. Reisner, “Thermal-Sprayed Thin-Film Thermal Batt. Cathodes.,” Procs. 6th Workshop for Battery Exploratory Dev., Williamsburg, Va., Jun. 21-24, 1999; D. E. Reisner, H. Ye, T. D. Xiao, R. A. Guidotti, and F. W. Reinhardt, “Thermal-Sprayed Thin-Film Cathodes for Thermal Battery,” Procs. 3rd Intnl. Symp. New Mats. for Fuel Cell and Modem Batt. Sys., Montreal, Canada, Jul. 4-8, 1999; pub. in J. New Mats. for Electrochemical Systems, 2 (1999), pp. 279-283; A. L. Golden, J. Dai, T. Danny Xiao, and D. E. Reisner, “Thermal Battery Using Plasma-Sprayed Thin-Film Cathodes,” Procs. 39th Power Sources Conf., Cherry Hill, N.J., Jun. 12-15, 2000; T. D. Xiao, J. Dai, J. Roth, R. Guidotti, and D. Reisner, “Thermal Sprayed Thin-Film Electrodes for Primary & Secondary Batts.,” 7th Workshop for Battery Dev., Philadelphia, Pa., Jun. 25-28, 2001; Reisner, D. E., et al. “Thermal-Sprayed Thin Film Cathodes for Thermal Battery,” Journal of New Materials for Electochemical Systems, 2, 279-283 (1999); and U.S. Pat. No. 6,794,086, Dai, et al., issued Sep. 21, 2004, and titled “Thermally Protective Salt Material For Thermal Spraying Of Electrode Materials.”

### BRIEF DESCRIPTION OF THE DRAWINGS

These and other features, aspects, and advantages of the present invention will become better understood with regard to the following description, appended claims, and accompanying drawings where:

FIGS. 1 and 2 show a multi-chip module that includes a thin film thermal battery in accordance with the present invention; and

FIG. 3 is a schematic of a security circuit in accordance with the present invention that can be used in the multi-chip module shown in FIGS. 1 and 2.

### DETAILED DESCRIPTION

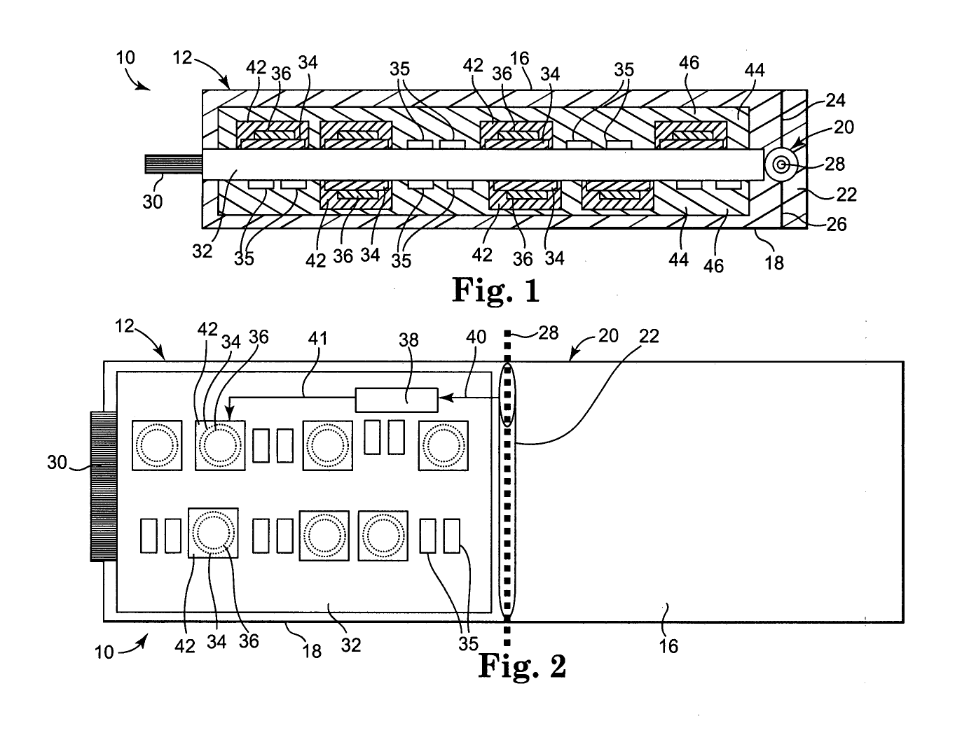

FIGS. 1 and 2 show an exemplary electronic system in accordance with the present invention in the form of multi-chip module 10. Multi-chip module 10 generally includes clamshell housing 12 protectively enclosing electronic package 14. Housing 12 includes cover 16 hingedly connected to base 18 by hinge member 20. Torsional-transducer 22 is embedded in hinge member 20 and incorporates piezoelectrically sensitive torsion arms 24 and 26. Arm 24 is associated with cover 16, while arm 26 is associated with base 18. Torsional transducer provides an unpowered, mechanical source of energy having a very long shelf-life. Torsional stress upon transducer 22, such as if housing 12 were to be opened by pivoting one or both of cover 16 and base 18 about the axis 28 of hinge member 20, causes torsional transducer 22 to generate an electrical output. The transducer 22 delivers enough output, e.g., a voltage and/or current, to initiate the function of thin film, thermal batteries 36, as will be described further below. Connector 30 allows module 10 to be functionally coupled to external items (not shown).

Cover 16 and/or base 18 may incorporate one or more security features that help protect the contents inside housing 12 from tampering, unauthorized reverse engineering, and the like. Examples of such security features include those described in U.S. Pat. Nos. 6,319,740 and 6,287,985; as well as in U.S. Patent Publication 2004/0222014, each of which is incorporated herein in its respective entirety for all purposes.

Inside housing 12, printed circuit board 32 is shown as being mounted to base 18. A plurality of integrated circuit chips 34 are mounted to printed circuit board 32. One or more thin-film, thermal batteries 36 are positioned inside housing 12 so as to be able to functionally interact in one or more desired ways with one or more corresponding chips 34. Common electrical components 35 (e.g., resistors, capacitors, etc.) are also shown schematically as being mounted to circuit board 32.

Thin-film, thermal batteries can generate both electrical power as well as significant quantities of heat (e.g., temperatures of more than 350° C. and even more than 500° C. to 800° C.) when caused to function. Either or both of these outputs can be used for security in response to a triggering event indicating that unauthorized tampering or analysis of module 10 is occurring. In some embodiments, one or more of such batteries 36 can be electrically coupled to one or more of chips 34 so as to power security activities (e.g., data protection activities such as erasing, overwriting, or otherwise corrupting data). In such modes, the thermal battery(ies) 36 can be positioned anywhere within module 10. In other embodiments, the significant heat output of a thermal battery 36 can be used to purposely destroy one or more corresponding chips 34 or other structures to prevent unauthorized access to sensitive information and structures incorporated into module 10. In such embodiments, the battery 36 preferably is placed in close physical proximity to the structures and/or data to be thermally damaged or destroyed so as to facilitate rapid thermal transfer. In other embodiments, both outputs of a thin-film thermal battery can be co-implemented upon occurrence of one or more triggering events. For purposes of illustration, FIGS. 1 and 2 show a thin-film, thermal battery 36 being respectively positioned over each chip 34 in multi-chip module 10.

An example of one kind of triggering event might occur when an unauthorized entity attempts to open housing 12. In this case, the resultant torsion forces upon transducer 22 cause transducer to generate an electrical output. The output is transmitted to amplifier 38 via line 40, and the amplifier 38 then outputs an amplified electrical output that is sent to one or more of batteries 36 via line 41. The signal causes the battery(ies) 36 to function. For purposes of illustration, only one such line 42 is shown. In actual practice, corresponding lines may be used to couple amplifier 38 to one or more of the other batteries 36, if desired. Alternatively, the power output of a first battery 36 may then be used to initiate the other batteries 36. Upon being initiated, a battery 36 will then provide the power to carry out desired security functions.

Preferably, each chip 34 and battery 36 is overcoated with a protective overcoat 42 that further enhances security. An overcoat 42 may provide active or passive protection. As examples of passive protection, an overcoat 42 may be formed of a material that masks the presence of a thermal battery, e.g., by incorporating materials or structure that confound or otherwise interfere with attempts to radiographically, sonically, or otherwise investigate the overcoated structures. As examples of active protection, an overcoat 42 may incorporate features, e.g., piezoelectric materials that can generate enough of an electrical output to power the underlying thermal battery 36 in the event overcoat 42 is unduly stressed. As another example of an active protection, the overcoat 42 may include material that is benign in a neutral pH environment, but become extremely corrosive or caustic in the event that the overcoat integrity is interrogated with corrosive or caustic agents. The resultant reactivity can be used to trigger battery operations and/or destroy underlying structures. Examples of such security measures are further described in U.S. Pat. Nos. 6,319,740; 6,287,985; and 6,013,318, each of which is incorporated herein in its respective entirety for all purposes.

It is also preferred to at least partially, and more preferably substantially fill the headspace 44 inside housing 12 with one or more suitable filler materials 46. This can be done through one or more suitable ports (not shown) after housing 12 is closed. In a manner similar to overcoat 42, the filler materials 46 desirably may incorporate active or passive security features, e.g., features, materials, or structures that help confound remote, unauthorized inspection (such as radiographic or sonographic inspection) or features, materials, or structures whose initiation triggers active security protections.

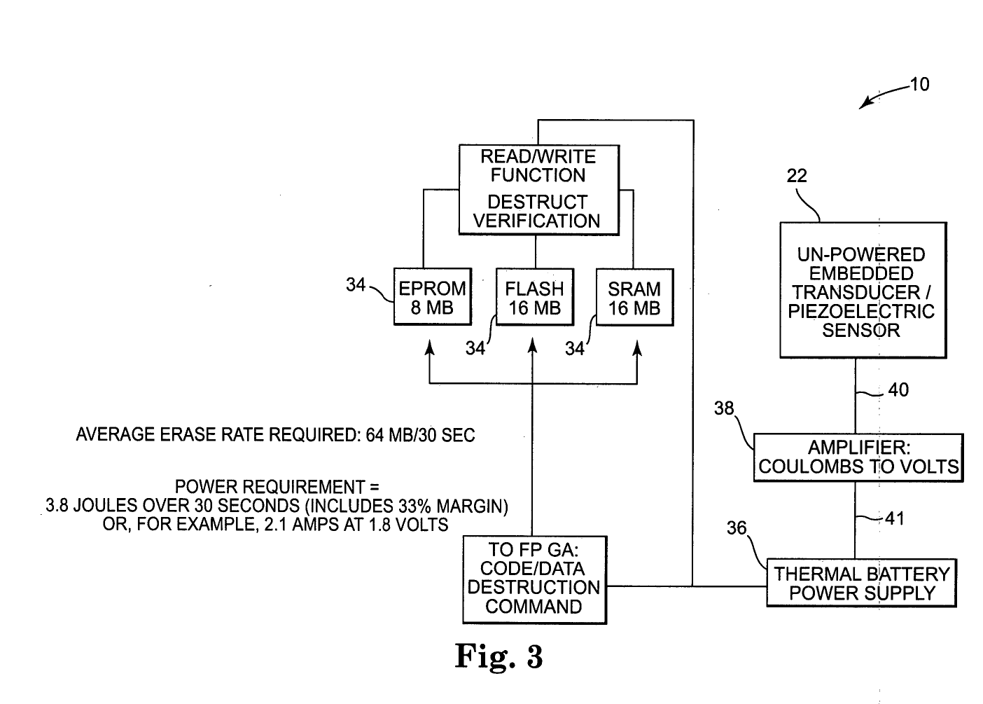

FIG. 3 schematically shows one way by which a thin-film, thermal battery 36 may be functionally incorporated into multi-chip module 10. In this mode of practice, the thermal battery 36 powers implementation of algorithm(s) that help ensure sensitive code and data is not reverse engineered by unauthorized personnel as well as algorithms that help to verify that the code and data protection has been carried out. Although not shown, automated destruction of the hardware, software, and data may occur in parallel with these operations. A triggering event, e.g., tampering with housing 12, causes torsional transducer 22 to output electrical energy, typically in the form of an electrical current. This current is sent to optional amplifier 38, which if needed or desired enhances or otherwise modifies the signal to provide sufficient voltage to initiate thermal battery 36. Thermal battery 36 then provides power to carry out security protection operations with respect to chips 34. For purposes of illustration, chips 34 include 8 MB EPROM, 16 MB FLASH, and 16 MB SRAM. According to one operation, the battery 36 powers an FPGA to destroy code and data on chips 34. In the meantime, battery 36 powers an algorithm to verify data destruction.

FIGS. 1-3 illustrate the practice of the present invention in the context of a multi-chip module 10. The invention is not intended to be limited to this particular context, but would also be very useful in any context in which one or more triggering events cause security concerns. By way of example, the principles of the present invention could be beneficially in other contexts such as single chip modules, and the like.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An electronic system comprising:
a thin film thermal battery incorporated into the electronic system so that the thermal battery can activate in response to a triggering event indicative of a breach of security with respect to the electronic system;
at least one microelectronic device incorporated into the electronic system; and
a security circuit that can carry out a security operation with respect to the at least one microelectronic device, wherein at least a portion of the security operation is carried out using power supplied by the thermal battery.

2. The electronic system of claim 1, wherein the thermal battery can provide electrical energy in response to the triggering event.

3. The electronic system of claim 1, wherein the thermal battery can provide thermal energy in response to the triggering event.

4. The electronic system of claim 1, further comprising a housing that encloses the at least one microelectronic device and the security circuit.

5. The electronic system of claim 4, wherein the thin film thermal battery is incorporated into the electronic system so that the thin film thermal battery can activate in response to an unauthorized breach of the housing.

6. An electronic system comprising:
a thin film thermal battery incorporated into the electronic system so that the thermal battery can activate and output thermal energy in response to a triggering event indicative of a breach of security with respect to the electronic system; and
at least one microelectronic device incorporated into the electronic system and positioned relative to the thermal battery so that thermal energy provided by the thermal battery in response to the triggering event can damage the microelectronic device.

7. The electronic system of claim 6, further comprising a security circuit that can carry out a security operation with respect to the at least one microelectronic device, wherein at least a portion of the security operation is carried out using power supplied by the thermal battery.

8. A security system that can be used with an electronic system, comprising:
a sensor that can generate an output in response to a triggering event detected by the sensor, the triggering event being indicative an unauthorized party attempting to access the electronic system; and
a thermal battery electrically coupled to the sensor so that the battery can be initiated to provide a power output in response to the output of the sensor, wherein the power output of the thermal battery can be used to carry out at least one security operation.

9. The security system of claim 8, wherein the thermal battery can be directly initiated by the sensor.

10. The security system of claim 8, wherein the thermal battery can be indirectly initiated by the sensor.

11. The security system of claim 8, wherein the sensor is piezoelectrically sensitive and the sensor output is an electrical signal.

12. The electronic system of claim 8, further comprising at least one microelectronic device.

13. The electronic system of claim 12, further comprising a security circuit that can carry out the security operation with respect to the at least one microelectronic device, wherein at least a portion of the security operation is carried out using power supplied by the thermal battery.

14. A method of providing security for a microelectronic device, the method comprising the steps of:
initiating a thin film thermal battery in response to a triggering event indicative of an attempt by an unauthorized entity to access the microelectronic device; and
using power supplied by the thin film thermal battery to carry out at least one security operation with respect to the microelectronic device.

15. The method of claim 14, wherein the security operation comprises activating a security circuit.

16. The method of claim 14, wherein the security operation comprises one of erasing, overwriting, or corrupting data.

17. The method of claim 14, wherein the security operation comprises thermally damaging at least a portion of the microelectronic device.

18. A method of providing security for a microelectronic device, the method comprising the steps of:
causing a piezoelectric transducer to generate an electrical signal in response to a triggering event indicative of an attempt by an unauthorized entity to access the device;
using the electrical signal of-the transducer to initiate a thin film thermal battery; and
using power supplied by the thin film thermal battery to carry out at least one security operation with respect to the device.

19. The method of claim 18, wherein the security operation comprises one of erasing, overwriting, or corrupting data.

20. The method of claim 18, wherein the security operation comprises thermally damaging at least a portion of the microelectronic device.
